(19) United States
(12) Patent Application Publication
(10) Pub. No.: US 2009/0234686 A1
(43) Pub. Date: Sep. 17, 2009

(54) SYSTEM AND METHOD FOR PROVIDING ACCESS CONTROL IN A COLLABORATIVE ENVIRONMENT

(76) Inventors: Al Chakra, Apex, NC (US); David M. Ogle, Cary, NC (US); David Louis Kaminsky, Chapel Hill, NC (US)

Correspondence Address: Steven E. Bach Attorney at Law, 10 Roberts Road, Newtown Square, PA, 19073, US

(21) Appl. No.: 12/049,732

(22) Filed: Mar. 17, 2008

(51) Int. Cl. G06Q 10/00

(52) U.S. Cl. 705/7

(57) ABSTRACT

A method, apparatus, and program product for providing access control in a collaborative environment are provided. A pool of approvable candidates for use in building an access control list for a project team are provided by matching attributes for potential candidates with requirements for the project, with the pool being larger than a projected size for the project team. In response to a vacant role on the project team, an invitation to join the project team is sent to an approvable candidate in the pool. At least one of the access control list or the pool is modified based upon an action by the approvable candidate.

### FIELD OF THE INVENTION

The invention relates to the field of computer security and more particularly to a system and method for providing fine grain access control in a collaborative environment using Access Control List back-up management.

### BACKGROUND

Collaborative environments must balance the trade-off between speed and security. Ensuring high levels of data integrity and security adversely affects speed as users are required to complete many steps in order to access the collaborative application. Allowing easy access to many users to enhance speed in a collaborative environment on the other hand adversely affects data integrity and security as many users can access the collaborative application without awareness of other users or a planned approach to data integrity and security. Another important factor affecting speed in a collaborative environment is gathering the right human resources to collaborate, as well as establishing a correct access control list. In an existing collaborative environment, assembling the right team and providing the correct access level to the members of the team is time consuming, as illustrated in the following example.

Current collaborative models do not restrict the size of a work group. Therefore, an access control list may comprise any number of members. However, practical considerations require that most work groups be restricted in size to ensure security of privileged content and to maintain working efficiency. Also, during a collaborative project the skill sets that are required may change. Thus, there is a need to add and remove individuals from the work group efficiently and easily.

A software engineer works for a large company and is currently leading a community project that is developing a software application. This project requires a specific set of skills from software developers who have extensive experience using and developing similar applications. The software engineer also needs people who can dedicate a certain number of hours per week towards this project. The maximum size of the team is ten members, as a larger size team would be very difficult to manage.

Unfortunately, the software engineer does not have a strong network and does not know which people should be on his team. His speed in executing the project is hampered because he cannot access the right people. Also, if a member of the project leaves after the project has begun, the software engineer does not know whom to contact with the right skills to fill the vacant spot on the team. Moreover, if the skill or other requirements change as the project evolves, the software engineer may not know where to find new team members to meet the changing requirements.

### SUMMARY

A method, apparatus, and program product for providing access control in a collaborative environment are provided. According to an exemplary embodiment, a pool of approvable candidates for use in building an access control list for a project team are provided by matching attributes for potential candidates with requirements for the project, with the pool being larger than a projected size for the project team. In response to a vacant role on the project team, an invitation to join the project team is sent to an approvable candidate in the pool. At least one of the access control list or the pool is modified based upon an action by the approvable candidate. An approvable candidate who accepts an invitation is added to the access control list. An approvable candidate who declines an invitation or fails to respond may be removed from the pool. In an exemplary embodiment, if an acceptance is not received, an invitation to join the project team is sent to another approvable candidate in the pool.

According to an exemplary embodiment, the pool of candidates is updated periodically, continuously or upon dropping below a threshold size. In this embodiment, a scan is performed of a data repository providing attributes for potential candidates. The candidates meeting the project requirements may be added to the pool randomly, or they may be ranked according to the goodness of fit of the candidates attributes with the project requirements.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of an apparatus for providing fine grain access control in a collaborative environment using access control list back-up management according to an exemplary embodiment of the present invention;

FIG. 2 is a flow diagram for a method for providing fine grain access control in a collaborative environment using access control list back-up management according to an exemplary embodiment of the present invention;

FIG. 3 is a flow diagram for providing a pool of approvable candidates for use in providing fine grain access control using access control list back-up management according to an exemplary embodiment of the present invention;

FIG. 4 is a flow diagram for replenishing a pool of approvable candidates for use in providing fine grain access control using access control list back-up management according to an exemplary embodiment of the present invention; and

FIG. 5 is a flow diagram for ranking candidates in a pool candidates for use in providing fine grain access control using access control list back-up management according to an exemplary embodiment of the present invention.

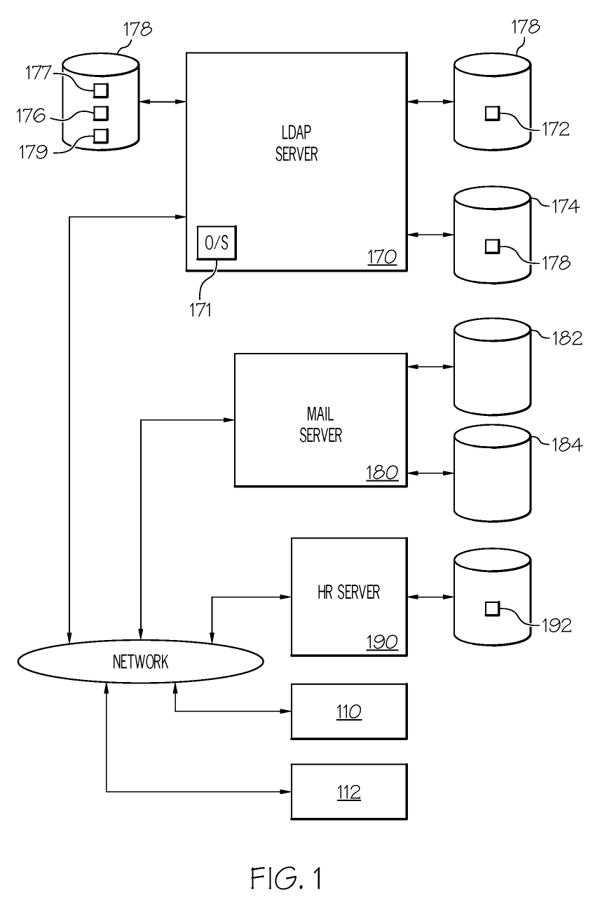

### DETAILED DESCRIPTION

The present invention provides a method, apparatus and program product for providing fine grain access control in a collaborative environment using Access Control List back-up management. According to an exemplary embodiment, a system comprises a secure server 170 having an operating system 171 operating thereon. The operating system may be any operating system suitable for a server, such as z/OS, WINDOWS®, Linux, or the like. One or more memories 178 are interconnected with the secure server 170.

Privileged content 172 is stored on at least one interconnected memory 178. The secure server is configured to control access to privileged content 172 by specific users or groups. There are pervasive and orthogonal methods to provide control of access to privileged content by specific users or groups. One method to control who has access and what access (such as reading, editing, replacing, etc) each user has is through the use of Lightweight Directory Access Protocol (LDAP). LDAP is similar to a database structure and follows a specific protocol with a well defined attribute about users and groups. Other mechanisms may be integrated within the operating system such as OS/390's remote access security application (RACF). The following description is directed to an LDAP access control system, however it should be understood that the invention encompasses other approaches to access control.

The secure server 170 controls access to the privileged content 172 through an Access Control List (ACL) 174. The ACL 174 may be a database or even a flat file associating attributes with the users or groups who are allowed access to privileged content 172. The ACL 174 I stored on one or more interconnected memories 178. A single server may have a plurality of ACLs 174 for various privileged content 172 or categories or classifications of privileged content. In order to maintain a high level of security for privileged content 172, typically only users or groups actively involved in a project to build or modify privileged content 172 are added to the ACL 174.

In an exemplary embodiment, an application 176 executable by the operating system 171, a pool 179 of approvable candidates for an ACL 174, and a project profile 177 are stored on one or more interconnected memories 178. The application 176, when executed by the operating system 171, performs steps for providing fine grain access control in a collaborative environment using Access Control List back-up management, as will be described below. The pool 179 comprises identification of candidates for a project should vacancies occur in the project team. The pool is created, for example, by screening employee profiles 192 which are located in a data repository, such as a human resources database, for example. The employees having the identified skills required for the project are added to the pool 179 as approvable candidates. Those candidates having the desired skills and other attributes for the project are added to the pool 179. The candidates in the pool are not added to the ACL 174 unless the candidate is assigned to the project.

The project profile comprises information about a specific project, such as start time, duration, number of employees to be placed on the project team, various roles within the project team, hours per week for each role, skills required for each role. In an exemplary embodiment, this information is collected and attributes are assigned to the data for each requirement (e.g. skill, availability, clearance, etc,).

When there is a vacancy on the project team, the application 176 automatically sends an invitation to a candidate listed in the pool 179. There are various methods and applications available to automatically generate a communication, and they will not be described here. In the illustrated example, the communication is an email message 182 sent through a network and delivered to the candidate on a networked device 110. Other means of automatic communication, however, are possible, such as an autodialed phone call, a page, a calendar program invitation, and the like.

The application 176 takes an appropriate action that is responsive to the action of the invited candidate. For, example, if the candidate declines the invitation to join the project team or fails to respond, the application removes the candidate from the pool 179 and sends an invitation to another candidate in the pool 179. If, the candidate accepts the invitation, the application automatically adds the candidate to the ACL 174.

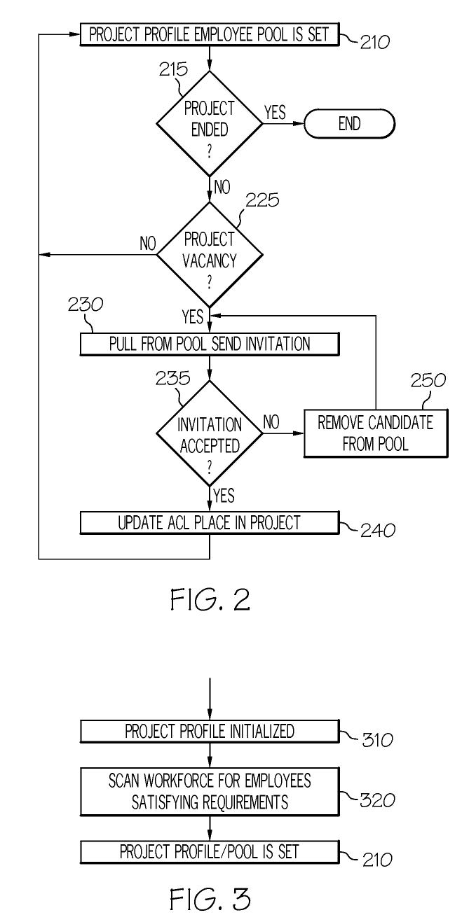

FIG. 2 shows a method for filling a vacancy on a project team using access control list back-up management according to an exemplary embodiment of the invention. As shown the application 176 sets a project profile 177 and a project pool 179 (step 210). That is, requirements are entered into a database or file to create a project profile 177. A pool of candidates that are approvable for the project are them identified by matching their attributes, such as skill and availability to the requirements in the project profile 177. The pool 179 may be a database, a flat file, or any other means suitable for maintaining a listing of employees suitable for a specific project.

The application 176 determines whether or not the project has ended (step 215). This may be accomplished, for example, by checking a project status recorded on a memory interconnected with the secure server 170 or accessible through a network. Alternatively, the application may determine whether or not the project has ended by querying a project leader or the like.

If the project is determined to have ended, then the application stops. If the project is determined not to have ended, then the application 176 determines whether or not there are vacancies on the project (step 225). This may be accomplished by retrieving a status from the ACL 174 for members of the project team, and comparing the results to a profile for the project team. For example, if the project team profile calls for ten members of the project team, and there are nine members of the project team listed on the ACL 174, then there is one vacancy on the project team.

If the application 176 determines that the project team has a vacancy, then the application pulls a candidate from the pool 179 and sends an invitation to join the project team to the candidate (step 230). Pulling a candidate may be accomplished, for example, by retrieving a first listed candidate from the pool 179. The application 176 may pull the first candidate added to the pool, the last candidate added to the pull, a random candidate, or a highest ranked candidate as will be described below. The application 176 automatically sends an invitation to the selected candidate using any suitable automatic communication function.

In the illustrated exemplary embodiment, the application 176 sends an invitation 182 to the selected candidate by email. Thus, the selected candidate retrieves the email invitation 182 from an email server 180 on a networked device 110. The selected candidate may then take one of three actions. The selected candidate may accept the invitation, decline the invitation, or fail to respond.

The application 176 determines whether or not the selected candidate has accepted the invitation (step 235). This may be accomplished. For example, by embedding a link in the email for accept that automatically sends a reply to the application 176. In another exemplary embodiment, a calendar function may be used to send the invitation and receive the response.

If the selected candidate accepts the invitation to join the project team, then the application 176 updates the ACL 174 by adding the selected candidate to the project team (step 240). If the candidate does not accept the invitation, then the application 176 pulls another candidate from the pool 179 and sends an invitation to the newly selected candidate (step 230). Optionally, the application 176 may remove the candidate who declined the invitation from the pool 179 (step 250). In an exemplary embodiment, the application 176 waits a predefined period of time for a response from the selected candidate, such as twenty-four hours, for example.

Thus, the application 176 automatically identifies an approvable candidate for the project team by matching employee profiles to the skill and other attribute requirements of the project, automatically invites a candidate to join a project team when a vacancy occurs, automatically updates the ACL 174 to add the candidate to the project team in response to an acceptance by the candidate, and automatically identifies and invites a new candidate in response if the first candidate does not accept the invitation. Accordingly, the project team is automatically maintained with qualified members.

According to an exemplary embodiment, as shown in FIG. 3, the pool 179 is created when a project is initialized. When a new project is launched, a project profile is initialized (step 310). A system user may enter information about the new project such as the name of the project, the documents that the project team will need access to, the size of the project team, the skills required to perform the project, duration of the project, hours per week required, and any other information that may be useful to manage the project. The application 176 may collect the information and initialize the project profile using a dialog box, a pull down menu, or any other suitable user interface function. In an exemplary embodiment attributes may be defined as required to make a match or preferred, such that a match may be performed on a goodness of fit basis, where the goodness of fit may be specified or may be a default value.

In an exemplary embodiment, a system user accesses application 176 through a networked device 112, which may be, for example, a personal computer, a personal digital assistant, or the like. The user selects initialize a project profile from a menu or the like and the application 176 then guides the user through the information collection and initialization process. Project requirements may be uniform across the project team or specific roles may be created having different requirements.

When the project profile is initialized, the application 176 scans the workforce for employees satisfying the project requirements (step 320). The application 176 may scan the workforce, for example, by retrieving employee profiles from a repository 192. More particularly, the application 176 may retrieve attributes from the employee profiles. These attributes may include skills, proficiencies, availability, and any other characteristics or information useful in making work assignments. Employees whose profiles match the project requirements are added to the pool 179 as approvable candidates. It should be noted that, depending upon how the project profile is created, a match may be an exact, match or a less exact match such as meeting a goodness of fit criteria or the like. The repository may comprise, for example, a database, a flat file or any other suitable data housing mechanism. Repository 192 may be accessed through the secured server or through another server 190 via a network. Repository 192 may be internal to an enterprise (such as a human resources database) or may extend beyond a single enterprise (such as a social network).

When the workforce has been scanned and approvable candidates have been added to the pool 179, the project profile and project pool are set (step 210). At this point the project team has vacancies for each slot on the team. Thus, the vacancies are filled using the method described above and illustrated in FIG. 2.

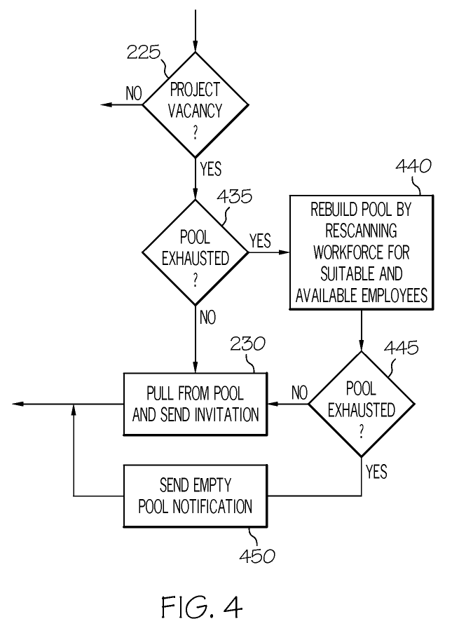

According to another exemplary embodiment, as shown in FIG. 4, the application 176 automatically replenishes the pool 179 of approvable candidates. In this embodiment, the application 176 determines whether or not there is a project team vacancy (step 225) as described above and illustrated in FIG. 2. If the application 176 determines that there is a vacancy, then the application next determines whether or not the pool 179 is exhausted (step 435). This determination may be accomplished, for example, by setting a threshold number of approvable candidates in the pool 179, retrieving the number of candidates currently in the pool 179, and comparing the current number of approvable candidates with the threshold number of approvable candidates. In an exemplary embodiment the threshold is zero. Alternatively, the threshold may be greater than zero.

If the pool 179 is not exhausted, then the application 176 pulls an approvable candidate and automatically sends an invitation to the selected candidate (step 230) as described above and illustrated in FIG. 2.

If the pool 179 is exhausted, then the application 176 rebuilds the pool 179 by rescanning the workforce for employees that meet the project requirements (step 440). It should be noted that employees who did not meet the project requirements during the initial scanning of the workforce because they did not meet availability requirements, for example, may meet the requirements during rescanning and therefore would be added to the approvable candidate pool 179. Rescanning step 440 may use the same matching criteria as the original scanning step, as described above and illustrated in FIG. 3. Alternatively, different matching criteria may be applied to broaden the pool 179.

After the rescanning step 440, the application 176 again determines whether or not the pool 179 is exhausted (step 445). If the pool 179 is not exhausted, then the application 176 pulls an approvable candidate and automatically sends an invitation to the selected candidate (step 230) as described above and illustrated in FIG. 2.

If the pool 179 is still exhausted after rescanning step 440, then the application 176 sends an empty pool notification (step 450). This notification may be any automated message, such as an email message, an automatic phone call, or the like. Moreover, the message may be sent to any combination of users or groups, such as the project manager, the human resources department, and any other individuals or groups that might take some form of action such as staffing decisions, hiring decisions, authorization of overtime or any other suitable action based on the lack of employees who meet the program requirements.

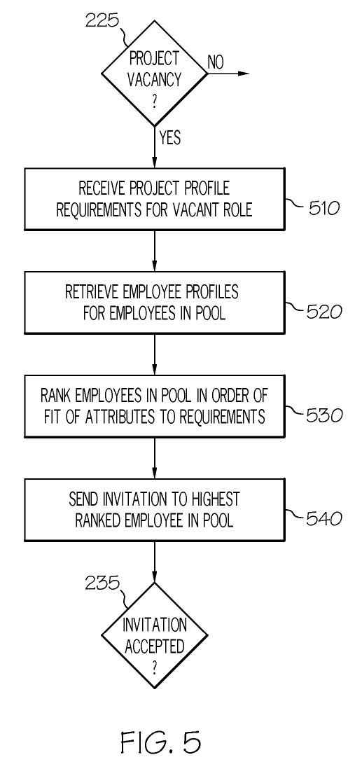

In an exemplary embodiment, as shown in FIG. 5, the application 176 ranks approvable employees within the pool 179. The method begins as described above and illustrated in FIG. 2. If the application 176 determines that there is a vacancy on the project in step 225, then the application retrieves the requirements for the vacant role from the project profile 177 (step 510). The requirements may be retrieved as a block, without prioritizing the various requirements. Alternatively, the application may retrieve one or more selected requirements for matching, perform a ranking step as will be described below, then retrieve additional requirements and repeat the ranking step. Moreover, the requirements may be retrieved on a continued or periodic basis in order to capture changes to the requirements as the project evolves.

The application also retrieves employee profiles or attributes from the pool 179 (step 520). In an exemplary embodiment, the application 176 continuously or periodically scans one or more repositories to always maintain the optimum back-up pool of approvable candidates. Thus, when new candidates become available through new hiring; when the skill or other attribute requirements change; when availability changes; or when other changes occur that may affect who would qualify for the pool 179, the pool is automatically updated.

The application 176 compares the employee attributes or profiles from the pool 179 with the requirements retrieved from the project profile 177 and ranks the employees (i.e., approvable candidates) in the pool 179 in order of the goodness of the fit between the employee attributes and the requirements (step 530). The goodness of fit may be determined using any of a variety of formulas that are available. These formulas are well known and will not be described in detail.

The application 176 sends an invitation to the highest ranked candidate (step 540). Again the invitation may be any form of automatic communication. Thus, in this embodiment, the best suited candidate is invited to join the project team and fill the vacant role.

The application then determines whether or not the invitation has been accepted (step 235). If the selected candidate accepts the invitation to join the project team, then the application 176 updates the ACL 174 by adding the selected candidate to the project team (step 240). If the candidate does not accept the invitation, then the application 176 pulls another candidate from the pool 179 and sends an invitation to the newly selected candidate, as described above and illustrated in FIG. 2.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain, store, communicate, propagate, or transport the program for use by or in connection with the instruction execution system, apparatus, or device.

The foregoing method may be realized by a program product comprising a machine-readable media having a machine-executable program of instructions, which when executed by a machine, such as a computer, performs the steps of the method. This program product may be stored on any of a variety of known machine-readable media, including but not limited to compact discs, floppy discs, USB memory devices, and the like. Moreover, the program product may be in the form of a machine readable transmission such as blue ray, HTML, XML, or the like.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The preceding description and accompanying drawing are intended to be illustrative and not limiting of the invention. The scope of the invention is intended to encompass equivalent variations and configurations to the full extent of the following claims.

What is claimed is:

1. A method for providing access control in a collaborative environment, comprising the steps of:
providing a pool of approvable candidates for use in building an access control list for a project team by relating attributes for potential candidates with requirements for a project, the pool being larger than a projected size for the project team;
in response to a vacant role on the project team, sending an invitation to join the project team to an approvable candidate in the pool;
modifying at least one of the access control list or the pool based upon an action by the approvable candidate.

2. The method of claim 1, wherein the modifying step comprises:
in response to receiving an acceptance from the approvable candidate adding the approvable candidate to the access control list.

3. The method of claim 1, wherein the modifying step comprises:
in response to receiving a refusal from the approvable candidate removing the approvable candidate from the pool.

4. The method of claim 1, further comprising the step of:
in response to not receiving an acceptance from the approvable candidate, sending an invitation to join the project team to another approvable candidate in the pool.

5. The method of claim 1, wherein the step of providing a pool of approvable candidates comprises scanning profiles of employees in a workforce for employees with profiles having attributes relating to the program requirements.

6. The method of claim 4, wherein the step of providing a pool of approvable candidates comprises ranking candidates based upon the relating of candidate skills with skill requirements for the open role, and wherein sending an invitation comprises sending an invitation to the highest ranking approvable candidate in the pool.

7. The method of claim 1, further comprising the steps of:
determining if the pool is exhausted;
if the pool is exhausted, scanning workforce for employees with attributes matching project requirements; and
adding employees with attributes matching project requirements to the pool of approvable candidates.

8. A program product comprising a computer-readable medium having encoded thereon computer-executable programs steps for providing access control in a collaborative environment, comprising:
first program instructions for providing a pool of approvable candidates for use in building an access control list for a project team by relating attributes for potential candidates with requirements for a project, the pool being larger than a projected size for the project team;
second program instructions for sending an invitation to join the project team to an approvable candidate in the pool in response to an vacant role on the project team; and
third program instructions for modifying at least one of the access control list or the pool based upon an action by the approvable candidate.

9. The program product of claim 8, wherein the modifying instructions comprise:
in response to receiving an acceptance from the approvable candidate adding the approvable candidate to the access control list.

10. The program product of claim 8, wherein the modifying instructions comprise:
in response to receiving a refusal from the approvable candidate removing the approvable candidate from the pool.

11. The program product of claim 8, further comprising:
fourth program instructions for, in response to not receiving an acceptance from the approvable candidate, sending an invitation to join the project team to another approvable candidate in the pool.

12. The program product of claim 8, wherein the instructions for providing a pool of approvable candidates comprise scanning profiles of employees in a workforce for employees with profiles having attributes relating to the program requirements.

13. The program product of claim 12, wherein the instructions for providing a pool of approvable candidates comprises ranking candidates based upon the relation of candidate skills with skill requirements for the open role, and wherein sending an invitation comprises sending an invitation to the highest ranking approvable candidate in the pool.

14. The program product of claim 8, further comprising:
fourth program instructions for determining if the pool is exhausted;
fifth program instructions for scanning workforce for employees with attributes matching project requirements if the pool is exhausted,; and
sixth program instructions for adding employees with attributes matching project requirements to the pool of approvable candidates.

15. An apparatus for providing access control in a collaborative environment, comprising:
a secure server having an operating system thereon;
a memory interconnected with the server;
an access control list stored on the memory operable to control access to privileged content to listed users; and
a program of instruction stored on the memory comprising a program of instruction executable by the operating system to:
provide a pool of approvable candidates for use in building an access control list for a project team by relating attributes for potential candidates with requirements for a project, the pool being larger than a projected size for the project team;
in response to an vacant role on the project team, send an invitation to join the project team to an approvable candidate in the pool;
modify at least one of the access control list or the pool based upon an action by the approvable candidate.
